(19) United States
(12) Patent Application Publication
(10) Pub. No.: US 2010/0183400 A1
(43) Pub. Date: Jul. 22, 2010

(54) SELF-DRILLING SCREW

(76) Inventor: HO-TIEN CHEN, Tainan City (TW)

Correspondence Address: J C PATENTS, 4 VENTURE, SUITE 250, IRVINE, CA, 92618, US

(21) Appl. No.: 12/357,704

(22) Filed: Jan. 22, 2009

(51) Int. Cl. F16B 35/00

(52) U.S. Cl. 411/394

(57) ABSTRACT

A self-drilling screw includes a thread section, a head on the thread section, and a drilling section. The thread section has plural threads. The drilling section includes two opposite cutting edges with an end point for cutting a hole in a workpiece, a discharging section for exhausting bits cut by the drilling section, a guiding section formed above the discharging section to lead the screw to vertically move in the workpiece, and two discharging grooves to lead cut bits to temporarily stay in the discharging section. When the screw is rotated to move in a workpiece, the cutting edges can drill a hole, with cut bits moving into the discharge section and exhausted out through the discharging grooves. After the screw moves into the workpiece for a certain depth, the guiding section can guide the screw to move straight and accurately in the workpiece.

### BACKGROUND OF THE INVENTION

1. Field of the Invention

This invention relates to a self-drilling screw, particularly to one having a drilling section that is provided with a cutting edge with a point for cutting a hole in a workpiece, a discharging section, a guiding section formed above the discharging section to be adjacent to a thread section and used to enable the screw vertically combined with a workpiece, and two discharging grooves. When the screw is rotated to move in a workpiece, the cutting edge can drill a hole, with cut bits moving into the discharge section and exhausted out of the drilled hole through the discharging grooves. After the screw moves into the workpiece for a certain depth, the guiding section can guide the screw to move straight in the workpiece, so the screw can be screwed accurately in the workpiece.

2. Description of the Prior Art

Commonly, a conventional self-drilling screw, as disclosed in U.S. Pat. No. 6,142,719, includes a head (3; 6), a thread section (2; 5) formed below the head, and a drilling section (1; 4) formed under the thread section. The drilling section (1; 4) is further provided with a first part (11; 41), a second part (12; 42), a first cutting edge (15; 45) and a second cutting edge (16; 46). And, two discharging grooves (13; 14; 43; 44) extend over the entire drilling section (1; 4) for discharging cut bits.

A first embodiment of the self-drilling screw in U.S. Pat. No. 6,142,719, the first cutting edge (15) of the drilling section (1) is formed in the first part (11) and the second cutting edge (16) is extended over the first part (11) and the second part (12). An edge (15′) of the second part (12) of the drilling section (1) is located inwardly of the first cutting edge (15) of the first part (11), unable to cut an edge. The radii of the first cutting edge (15) and the second cutting edge (16) are smaller than a half of a pitch diameter (D2) of the thread section (2) and bigger than a half of a root diameter (D1) of the thread section (2).

A second embodiment of the self-drilling screw in U.S. Pat. No. 6,142,719, the first cutting edge (45) of the drilling section (1) is extended over the first part (41) and the second part (42). An edge (46′) of the second part (42) is offset outwardly with respect to the second cutting edge (46) in the first part (41). The radii of the first cutting edge (45) and the second cutting edge (46) are equal to a half of a pitch diameter (D4) of the thread section (5).

According to U.S. Pat. No. 6,142,719, the first cutting edge (15; 45) and the second cutting edge (16; 46) are employed to drill a hole in a workpiece, with drillings discharged through the discharging grooves. However, as the radius (R1) of the opposite side of the second cutting edge (16) is smaller than a half of the root diameter (D1) of the thread section (2), the screw is apt to decline while passing the workpiece owing to no supporting part, keeping the thread section (2; 5) unable to be vertically combined with workpiece.

### SUMMARY OF THE INVENTION

The object of this invention is to offer a self-drilling screw able to be vertically screwed into a workpiece smoothly with precision.

The main characteristics of the invention are a head, a thread section, and a drilling section. The drilling section includes two opposite cutting edges with an end point for cutting a hole in a workpiece, a discharging section for exhausting bits cut by the drilling section, a guiding section formed above the discharging section to be adjacent to the thread section, and two discharging grooves. When the screw is rotated to move in a workpiece, the cutting edges can drill a hole, with cut bits moved into the discharge section and exhausted out of the drilled hole through the discharging grooves. After the screw moves into the workpiece for a certain depth, the guiding section can guide the screw to move straight in the workpiece, so the screw can be screwed accurately in the workpiece.

Further, the guiding section can further be provided with two cutting wings that are to break off as soon as touching a metal workpiece so as to enable the thread section screwed in the metal workpiece combined with a wood workpiece.

### BRIEF DESCRIPTION OF DRAWINGS

This invention is better understood by referring to the accompanying drawings, wherein:

FIG. 1 is a side view of a first preferred embodiment of a self-drilling screw in the present invention;

FIG. 2 is a cross-sectional view of the first preferred embodiment of a self-drilling screw in the present invention, showing it is being inserted in a metal workpiece;

FIG. 3 is a cross-sectional view of the first preferred embodiment of a self-drilling screw in the present invention, showing it being completely inserted in the metal workpiece;

FIG. 4 is a side view of a second preferred embodiment of a self-drilling screw in the present invention;

FIG. 5 is a cross-sectional view of the second preferred embodiment of a self-drilling screw in the present invention, showing it is being inserted in a wood workpiece to be combined with a metal workpiece, with two cutting wings just contacting with the metal workpiece;

FIG. 6 is a cross-sectional view of the second preferred embodiment of a self-drilling screw in the present invention, showing it is being inserted in the wood workpiece to be combined with the metal workpiece, with the cutting wings broken off while passing the metal workpiece; and

FIG. 7 is a cross-sectional view of the second preferred embodiment of a self-drilling screw in the present invention, showing it being completely inserted in the wood workpiece and the metal workpiece.

### DETAILED DESCRIPTION OF THE PREFERRED EMBODIMENT

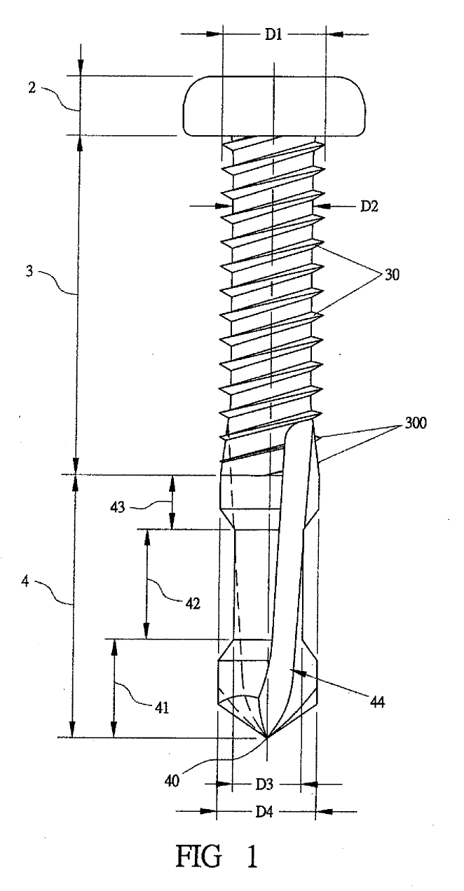

As shown in FIGS. 1˜3, a first preferred embodiment of a self-drilling screw in the present invention includes a head 2, a thread section 3 and drilling section 4.

The head 2 can be formed in any shape to be available for diverse drivers, in accordance with practical requirement.

The thread section 3 is formed under the head 2, usually provided with complete threads 30 having a shape or a pitch as practically required. Of course, the threads can be formed incomplete if necessary.

The drilling section 4 is formed under the thread section 3, provided with a cutting edge 41 including a point 40 and utilized to drill a metal workpiece (A), a discharging section 42 formed above the cutting edge 41 for temporarily accumulating cut bits to be exhausted out, a guiding section 43 formed above the discharging section 42 to connect with the thread section 3 and used to correct the screw for vertically combining with a metal workpiece (A), and two discharging grooves 44 extended up through the drilling section 41 and the discharging section 42 to some threads 300 of the thread section 3, with the threads 300 formed incomplete.

Further, as shown in FIG. 1, the outside diameter (D4) of the cutting edge 41 and the guiding section 43 is smaller than a pitch diameter (D1) of the thread section 3 and bigger than a root diameter (D2) of the thread section 3. And, the outside diameter (D3) of the discharging section 42 of the drilling section 4 is smaller than the root diameter (D2) of the thread section 3.

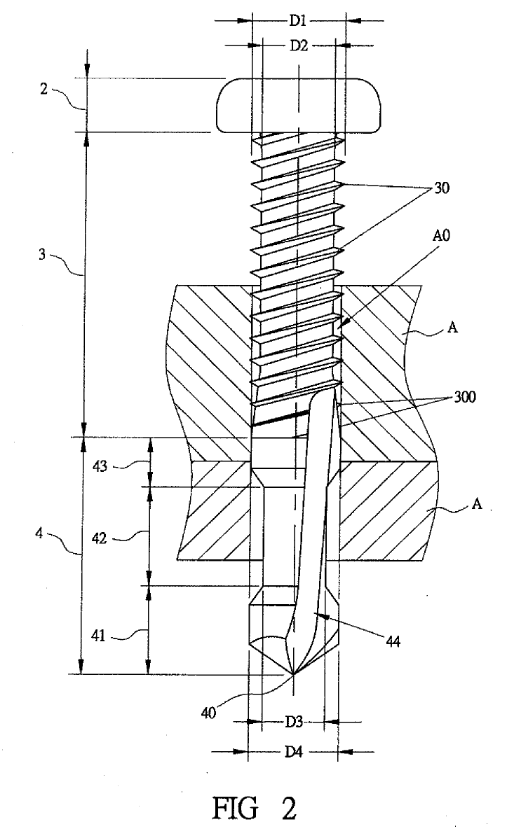

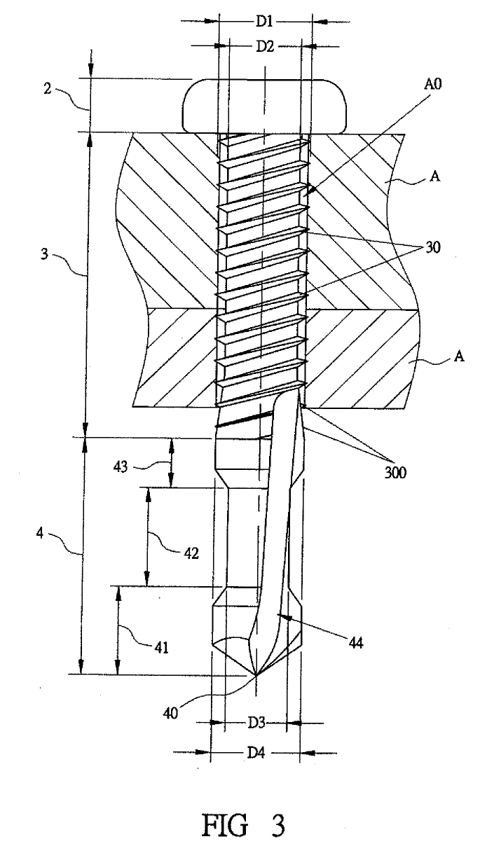

In using, as shown in FIGS. 2 and 3, when the self-drilling screw is to combine with a metal workpiece (A), the drilling section 4 can first drill the metal workpiece (A) quickly, with the discharging section 42 to receive bits cut by the drilling section 4 and squeezed upward along the discharging grooves 44 to be exhausted while continuing drilling. During drilling, a hole (AO) is to be bored in the metal workpiece (A), with a diameter equal to the outside diameter (D4) of the cutting edge 41 and the guiding section 43, so that the guiding section 43 can correctly lead the screw to vertically enter the metal workpiece (A) with precision as the drilling section 4 has drilled in a certain depth of or almost through the metal workpiece (A).

As shown in FIG. 4, a second preferred embodiment of a self-drilling screw in the present invention includes a head 2, a thread section 3 and drilling section 4.

The head 2 can be formed in any shape to be available for diverse drivers, in accordance with practical requirement.

The thread section 3 is formed under the head 2, usually provided with complete threads 30 having a shape or a pitch as practically required. Of course, the threads can be formed incomplete if necessary.

The drilling section 4 is formed under the thread section 3, provided with two opposite cutting edges 41 with an end point 40 and utilized to drill a metal workpiece (A), a discharging section 42 formed above the cutting edge 41 for temporarily accumulating cut bits to be exhausted out, a guiding section 43′ formed above the discharging section 42 to connect with the thread section 3, and a discharging groove 44 extended up from the cutting edge 41 through the discharging section 42 to the guiding section 43′ for conveniently exhausting drillings to lower resistance of drilling. Formed at two corresponding sides of the guiding section 43′ are two cutting wings 45, which can cut a hole in a wood workpiece (B) and a slot in the metal workpiece (A) so as to enable the thread section 3 to swiftly pass through the wood workpiece (B) to combine with the metal workpiece (A).

The outside diameter (D4) of the cutting edge 41 and the guiding section 43 is smaller than the pitch diameter (D1) of the thread section 3 and bigger than the root diameter (D2) of the thread section 3. The outside diameter (D3) of the discharging section 42 of the drilling section 4 is smaller than or equal to the root diameter (D2) of the thread section 3. And, the outside diameter (D5) of the cutting wings 45 is bigger than the pitch diameter (D1) of the thread section 3.

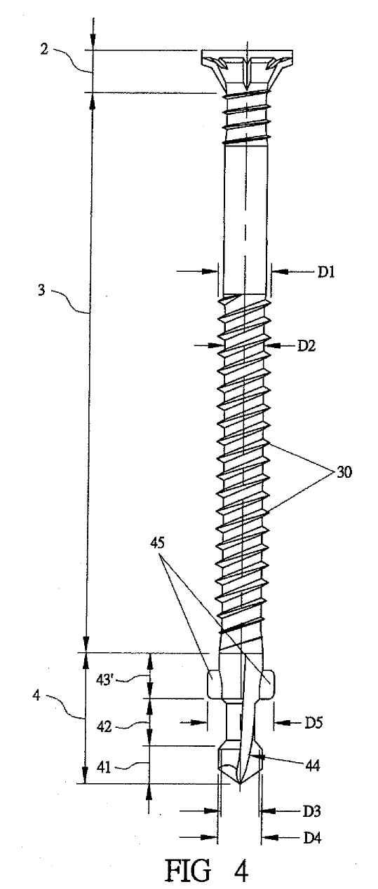

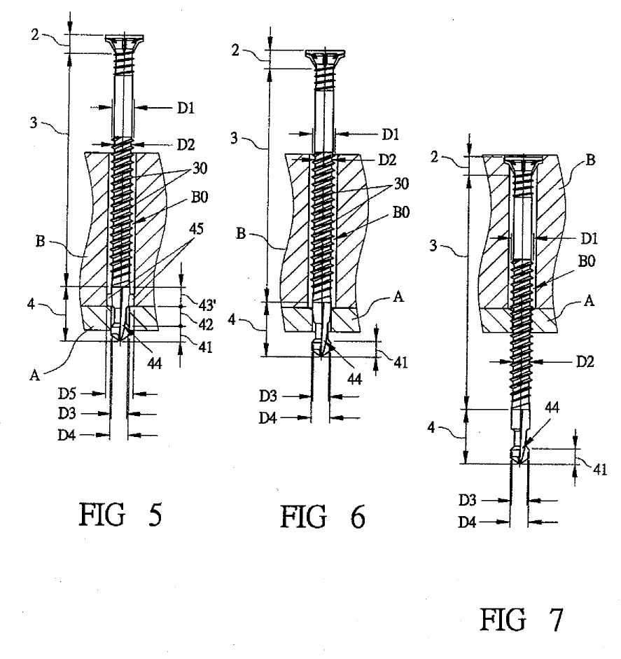

As shown in FIGS. 5˜7, the second embodiment of the self-drilling screw is employed to combine the wood workpiece (B) with the metal workpiece (A) thereunder. In using, the drilling section 4 first drill a guiding hole in the wood workpiece (B) and then, the cutting wings 45 drill a hole (BO) to keep the thread section 3 not combined with and able to rotate in the wood workpiece (B). By the time, the bits cut by the cutting wings 45 can be exhausted upward through the discharging groove 44. The drilling section 4 is to start drilling the metal workpiece (A) after passing through the wood workpiece (B), with the bits cut by the drilling section 4 temporarily moved and stored in the discharging section 42 and exhausted out through the discharging groove 44. As soon as the cutting wings 45 touch the metal workpiece (A), they are to immediately break off. The guiding section 43′ can then guide the screw to vertically enter and combine with the metal workpiece (A) smoothly, achieving the purpose of combining the wood workpiece (B) with the metal workpiece (A) thereunder.

While the preferred embodiment of the invention has been described above, it will be recognized and understood that various modifications may be made therein and the appended claims are intended to cover all such modifications that may fall within the spirit and scope of the invention.

What is claimed is:

1. A self-drilling screw comprising:
a head;
a thread section formed under said head and provided with plural threads; and a drilling section formed under said thread section and provided with two opposite cutting edges with an end point and utilized to drill a metal workpiece, a discharging section formed above said cutting edge for temporarily accumulating cut bits to be exhausted out, a guiding section formed above said discharging section to connect with said thread section for guiding said screw to vertically enter and combine with the metal workpiece, two discharging grooves extended up from said point through said drilling section and said discharging section to some of said threads of said thread section, said threads thus formed incomplete.

2. The self-drilling screw as claimed in claim 1, wherein an outside diameter of said cutting edge and said guiding section of said drilling section is smaller than a pitch diameter of said thread section and bigger than a root diameter of said thread section.

3. The self-drilling screw as claimed in claim 1, wherein an outside diameter of said discharging section of said drilling section is smaller than a root diameter of said thread section.

4. The self-drilling screw as claimed in claim 1, wherein said guiding section of said thread section is provided with two opposite cutting wings.

5. The self-drilling screw as claimed in claim 4, wherein an outside diameter of said cutting wings is larger than a pitch diameter of said thread section.
